(19) United States
(12) Patent Application Publication
(10) Pub. No.: US 2025/0175354 A1
(43) Pub. Date: May 29, 2025

(54) SECURITY DEVICE AND METHOD OF FABRICATING THE SAME

(71) Applicant: SAMSUNG ELECTRONICS CO., LTD., SUWON-SI (KR)

(72) Inventors: KILHO LEE, Suwon-si (KR); DAESHIK KIM, Suwon-si (KR)

(21) Appl. No.: 18/668,338

(22) Filed: May 20, 2024

(30) Foreign Application Priority Data
Nov. 23, 2023 (KR) 10-2023-0164044

(51) Int. Cl. H04L 9/32; H04L 9/08; H10N 50/20; H10N 50/80; H10N 59/00

(52) U.S. Cl. CPC H04L 9/3278; H10N 50/20; H10N 50/80; H10N 59/00; H04L 9/0869; H04L 2209/12

(57) ABSTRACT

A security device includes a substrate extending in a first direction and a second direction, wherein the first direction intersects the second direction, first physical unclonable function (PUF) cells disposed on the substrate, wherein the first PUF cells are spaced apart from each other in the first direction and the second direction, and second PUF cells disposed on the substrate, wherein the second PUF cells are spaced apart from each other in the first direction and the second direction. Each of the plurality of first PUF cells and the plurality of second PUF cells includes a pinned magnetic layer, a free magnetic layer, and a tunnel barrier layer disposed between the pinned magnetic layer and the free magnetic layer.

### CROSS-REFERENCE TO RELATED APPLICATION

This U.S. nonprovisional application claims priority under 35 U.S.C § 119 to Korean Patent Application No. 10-2023-0164044, filed on Nov. 23, 2023, in the Korean Intellectual Property Office, the disclosure of which is incorporated by reference hereby in its entirety.

### TECHNICAL FIELD

The present disclosure relates to a security device, and more particularly, to a security device including a magnetic tunnel junction element.

### DISCUSSION OF RELATED ART

Security and encryption technologies have become increasingly important with regard to communication and mobile devices. Software generated keys can be vulnerable to hacking. Hardware-based security measures are currently being developed.

For example, semiconductor devices having a physical unclonable function (PUF) has been developed. The PUF refers to a technique that utilizes differences in the fine structure of semiconductors produced in the same fabrication process to generate and utilize security keys. However, as the PUF uses a difference in fine physical structure of fabrication process, the PUF is sensitive to ambient noise. Additionally, the PUF's dependence on these differences in fine physical structure makes it susceptible to security issues when used for an extended period.

### SUMMARY

Some embodiments of the present disclosure provide a security device capable of generating random numbers to re-establish security keys and a method of fabricating the same.

According to embodiments of the present disclosure, a security device includes a substrate extending in a first direction and a second direction, wherein the first direction intersects the second direction; a plurality of first physical unclonable function (PUF) cells disposed on the substrate, wherein the plurality of first PUF cells are spaced apart from each other in the first direction and the second direction; and a plurality of second physical unclonable function (PUF) cells disposed on the substrate, wherein the second PUF cells are spaced apart from each other in the first direction and the second direction, wherein each of the plurality of first PUF cells and the plurality of second PUF cells includes a pinned magnetic layer, a free magnetic layer, and a tunnel barrier layer disposed between the pinned magnetic layer and the free magnetic layer, and wherein a magnetization direction of the pinned magnetic layer of each plurality of first PUF cells is antiparallel to a magnetization direction of the pinned magnetic layer of each of the plurality of second PUF cells.

According to embodiments of the present disclosure, a security device includes a plurality of first physical unclonable function (PUF) cells and a plurality of second physical unclonable function (PUF) cells, wherein the plurality of first PUF cells and the plurality of second PUF cells are alternately arranged in a first direction and spaced apart from each other in the first direction; and a spin-orbit torque pattern extending in the first direction, wherein the spin-orbit torque patter is in contact with the plurality of first PUF cells and the plurality of second PUF cells, wherein each of the plurality of first PUF cells and the plurality of second PUF cells includes a pinned magnetic layer, a free magnetic layer, and a tunnel barrier layer disposed between the pinned magnetic layer and the free magnetic layer, wherein a magnetization direction of the pinned magnetic layer of each of the plurality of first PUF cell is antiparallel to a magnetization direction of the pinned magnetic layer of each second PUF cell, and wherein the spin-orbit torque pattern is in contact with the free magnetic layer of each of the plurality of first PUF cells and the plurality of second PUF cells.

### BRIEF DESCRIPTION OF THE DRAWINGS

FIG. 1 illustrates a plan view of a security device according to some embodiments of the present disclosure.

FIG. 2 illustrates a cross-sectional view taken along line I-I′ of FIG. 1, showing a security device according to some embodiments of the present disclosure.

FIG. 3 illustrates a cross-sectional view taken along line II-II′ of FIG. 1, showing a security device according to some embodiments of the present disclosure.

FIG. 4 illustrates a conceptual diagram showing magnetization directions of pinned magnetic layers and free magnetic layers in first PUF cells and second PUF cells according to some embodiments of the present disclosure.

FIG. 5 illustrates a graph showing energy values of free magnetic layers in first PUF cells and second PUF cells according to some embodiments of the present disclosure.

FIG. 6 illustrates a cross-sectional view taken along line I-I′ of FIG. 1, showing a security device according to some embodiments of the present disclosure.

FIG. 7 illustrates a cross-sectional view taken along line II-II′ of FIG. 1, showing a security device according to some embodiments of the present disclosure.

FIG. 8 illustrates a cross-sectional view taken along line I-I′ of FIG. 1, showing a security device according to some embodiments of the present disclosure.

FIG. 9 illustrates a cross-sectional view taken along line II-II′ of FIG. 1, showing a security device according to some embodiments of the present disclosure.

FIG. 10A illustrates a cross-sectional view taken along line I-I′ of FIG. 1, showing a method of fabricating a security device according to some embodiments of the present disclosure.

FIG. 10B illustrates a cross-sectional view taken along line II-II′ of FIG. 1, showing a method of fabricating a security device according to some embodiments of the present disclosure.

FIG. 11A illustrates a cross-sectional view taken along line I-I′ of FIG. 1, showing a method of fabricating a security device according to some embodiments of the present disclosure.

FIG. 11B illustrates a cross-sectional view taken along line II-II′ of FIG. 1, showing a method of fabricating a security device according to some embodiments of the present disclosure.

### DETAILED DESCRIPTION OF THE EMBODIMENTS

The following will now describe in detail some embodiments of the present disclosure with reference to the accompanying drawings.

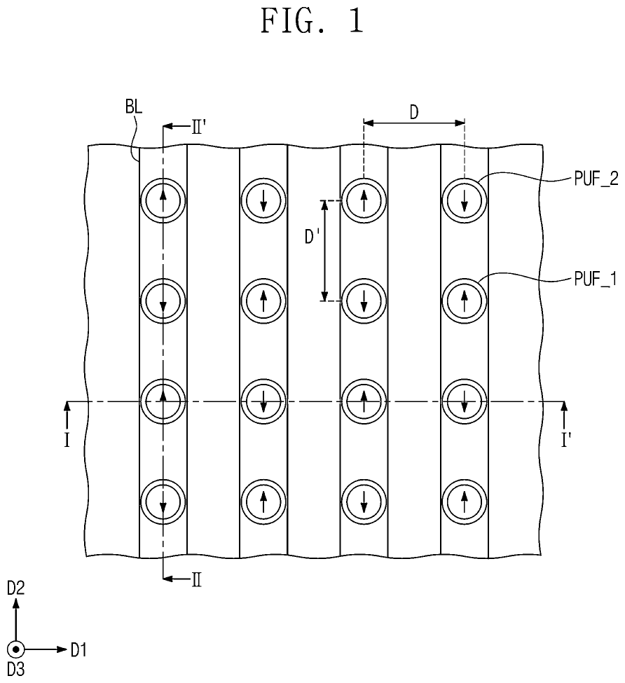

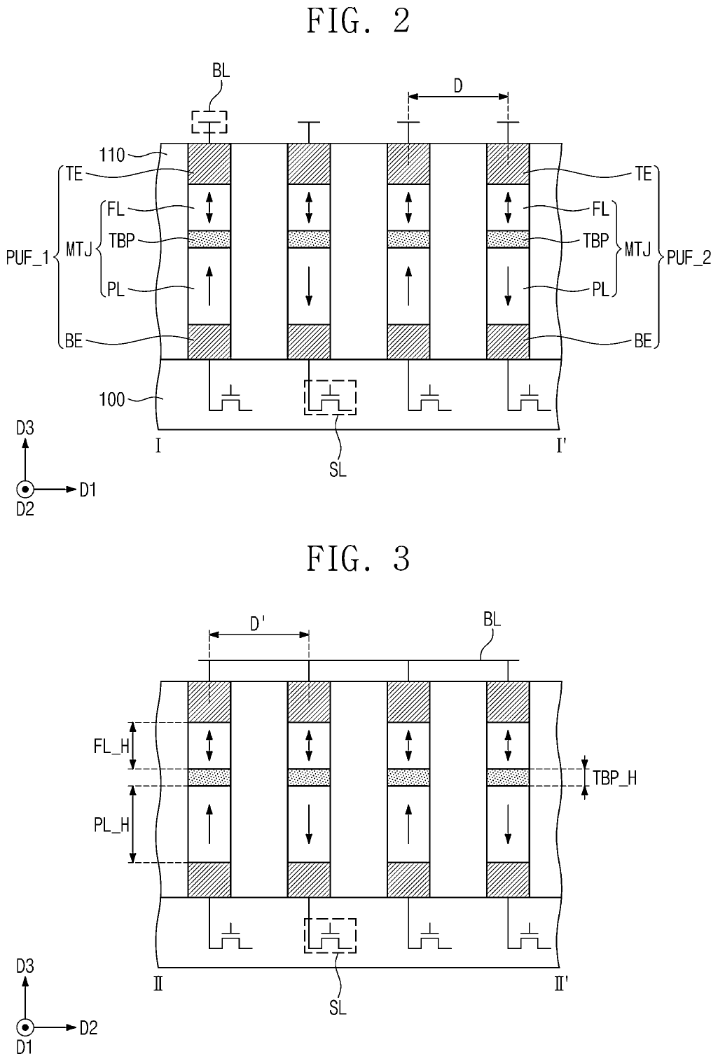

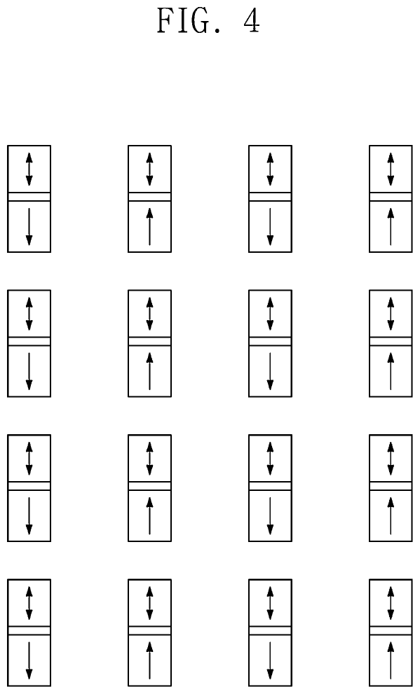

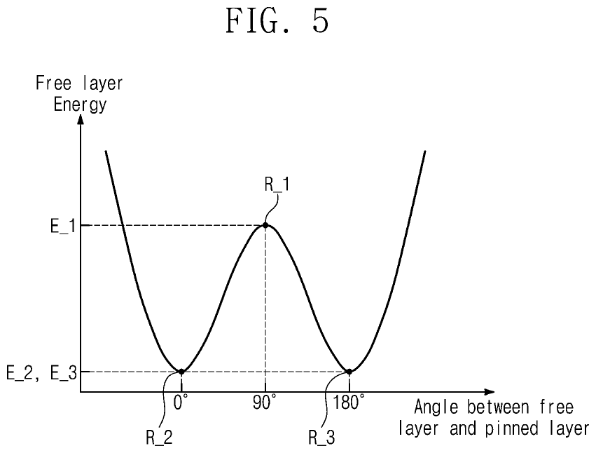

FIG. 1 illustrates a plan view of a security device according to some embodiments of the present disclosure. FIG. 2 illustrates a cross-sectional view taken along line I-I′ of FIG. 1, depicting a security device according to some embodiments of the present disclosure. FIG. 3 illustrates a cross-sectional view taken along line II-II′ of FIG. 1, showing a security device according to some embodiments of the present disclosure. FIG. 4 illustrates a conceptual diagram depicting magnetization directions of pinned magnetic layers and free magnetic layers in first PUF cells and second PUF cells according to some embodiments of the present disclosure. FIG. 5 illustrates a graph representing energy values of free magnetic layers in first PUF cells and second PUF cells according to some embodiments of the present disclosure.

Referring to FIGS. 1 to 3, a substrate 100 is provided, which extends in a first direction D1 and a second direction D2 that intersect each other. In some embodiments, the first direction D1 and the second direction D2 may be perpendicular to each other. The substrate 100 may be a semiconductor substrate comprising materials such as, but not limited to, silicon (Si), silicon-on-insulator (SOI), silicon-germanium (SiGe), germanium (Ge), or gallium-arsenic (GaAs).

A plurality of selection elements SL may be disposed on substrate 100. In some embodiments, the selection elements SL may be field effect transistors.

A cell dielectric layer 110 may be disposed on substrate 100. The cell dielectric layer 110 may comprise one or more materials, such as silicon oxide, silicon nitride, and silicon oxynitride.

First physical unclonable function (PUF) cells PUF_1 and second physical unclonable function (PUF) cells PUF_2 may be disposed on the substrate 100 and embedded within the cell dielectric layer 110. The first PUF cells PUF_1 and the second PUF cells PUF_2 may be spaced apart from each other in the first direction D1 and the second direction D2. A pinned magnetic layer PL of each of the first PUF cells PUF_1 may have a magnetization direction antiparallel to that of a pinned magnetic layer PL of each of the second PUF cells PUF_2. In some embodiments, a ratio of the number of the first PUF cells PUF_1 to the number of the second PUF cells PUF_2 may be approximately 1:1, and the first PUF cells PUF_1 and the second PUF cells PUF_2 may be alternately disposed along the first direction D1 and the second direction D2. The first PUF cells PUF_1 and the second PUF cells PUF_2 may be spaced apart at a substantially equal interval D from each other in the first direction D1 and the second direction D2. For example, a first spacing distance D between the center of a first PUF cell PUF_1 and the center of an adjacent second PUF cell PUF_2 in the first direction D1 may be substantially equal to a second spacing distance D′ between the center of the first PUF cell PUF_1 and the center of an adjacent second PUF cell PUF_2 in the second direction D2.

Each of the first PUF cells PUF_1 and the second PUF cells PUF_2 may comprise a pinned magnetic layer PL, a free magnetic layer FL, and a tunnel barrier layer TBP disposed between the pinned magnetic layer PL and the free magnetic layer FL. In some embodiments, each of the first PUF cells PUF_1 and the second PUF cells PUF_2 may further comprise a bottom electrode BE connected to a corresponding one of the selection elements SL and a top electrode TE connected to a bit line BL. The pinned magnetic layer PL, the free magnetic layer FL, and the tunnel barrier layer TBP may be disposed between the bottom electrode BE and the top electrode TE. The bottom electrode BE may comprise a conductive metal nitride, such as titanium nitride or tantalum nitride. The top electrode TE may comprise at least one metal selected from the group consisting of Ta, W, Ru, and Ir, or a conductive metal nitride, such as TiN. The tunnel barrier layer TBP may comprise at least one material selected from the group consisting of a magnesium (Mg) oxide layer, a titanium (Ti) oxide layer, an aluminum (Al) oxide layer, a magnesium-zinc (MgZn) oxide layer, a magnesium-boron (MgB) oxide layer, and a hafnium (Hf) oxide layer.

The pinned magnetic layer PL may have a magnetization direction that is fixed in one direction, while the free magnetic layer FL may have a magnetization direction that can be switched to be parallel or antiparallel to the magnetization direction of the pinned magnetic layer PL. The magnetization directions of the pinned magnetic layer PL and the free magnetic layer FL may be substantially perpendicular to an interface of the tunnel barrier layer TBP. In such cases, the pinned magnetic layer PL and the free magnetic layer FL may each comprise at least one material selected from the group consisting of a perpendicular magnetic material (e.g., CoFeTb, CoFeGd, or CoFeDy), a perpendicular magnetic material having an L10 structure, CoPt with a hexagonal close packed (HCP) lattice structure, and a perpendicular magnetic structure. The perpendicular magnetic material having the L10 structure may comprise at least one material selected from the group consisting of FePt, FePd, CoPd, and CoPt, each having the L10 structure. The perpendicular magnetic structure may comprise alternating and repeatedly stacked magnetic layers and non-magnetic layers. For example, the perpendicular magnetic structure may comprise at least one structure selected from the group consisting of (Co/Pt) n, (CoFe/Pt) n, (CoFe/Pd) n, (Co/Pd) n, (Co/Ni) n, (CoNi/Pt) n, (CoCr/Pt) n, and (CoCr/Pd) n, where n represents the number of stacked layers. The pinned magnetic layer PL may have a vertical thickness PL_H that is greater than a vertical thickness FL_H of the free magnetic layer FL. In this description, the vertical thickness is measured in a third direction D3 perpendicular to a top surface of the substrate 100. For example, a ratio of the vertical thickness PL_H of the pinned magnetic layer PL to the vertical thickness FL_H of the free magnetic layer FL may be in a range of about 3:1 to about 5:1. By having the vertical thickness PL_H of the pinned magnetic layer PL greater than the vertical thickness FL_H of the free magnetic layer FL, the security device may exhibit an increase in data retention. Furthermore, the increased vertical thickness PL_H of the pinned magnetic layer PL relative to the vertical thickness FL_H of the free magnetic layer FL may allow for an increased vertical thickness TBP_H of the tunnel barrier layer TBP, thereby enhancing tunnel magnetoresistance characteristics. The vertical thickness TBP_H of the tunnel barrier layer TBP may range from about 1 nm to about 2 nm.

According to embodiments of the present disclosure, and with reference to FIGS. 1 and 4, the pinned magnetic layer PL of each of the first PUF cells PUF_1 may have a magnetization direction antiparallel to that of the pinned magnetic layer PL of each of the second PUF cells PUF_2. In some examples, the first PUF cells PUF_1 and the second PUF cells PUF_2 may be alternately arranged along the first direction D1 and the second direction D2.

In embodiments of the present disclosure, a stray magnetic field generated from the pinned magnetic layer PL of each of the first PUF cells PUF_1 may be cancelled by a stray magnetic field generated from the pinned magnetic layer PL of each of the second PUF cells PUF_2. As a result, it may be possible to substantially reduce or remove a stray magnetic field that affects the free magnetic layer FL of each of the first PUF cells PUF_1 and the second PUF cells PUF_2.

According to some embodiments, a ratio of the number of the first PUF cells PUF_1 to the number of the second PUF cells PUF_2 may be about 1:1. Furthermore, the first PUF cells PUF_1 and the second PUF cells PUF_2 may be spaced apart at substantially the same interval from each other. Consequently, it may be possible to effectively reduce or remove a stray magnetic field generated from the pinned magnetic layer PL.

With reference to FIG. 5, in embodiments of the present disclosure, the free magnetic layer FL of each of the first PUF cells PUF_1 and the second PUF cells PUF_2 may have an energy value E_1 at a first state R_1, an energy value E_2 at a second state R_2, and an energy value E_3 at a third state R_3. In this description, the first state R_1 may refer to a state where the magnetization directions of the free magnetic layer FL and the pinned magnetic layer PL form an angle of about 90° (i.e., the magnetization directions are substantially orthogonal to each other). The second state R_2 may refer to a state where the magnetization directions of the free magnetic layer FL and the pinned magnetic layer PL form an angle of about 0° (i.e., the magnetization directions are substantially parallel to each other). The third state R_3 may refer to a state where the magnetization directions of the free magnetic layer FL and the pinned magnetic layer PL form an angle of about 180° (i.e., the magnetization directions are substantially antiparallel to each other). The energy values E_1, E_2, and E_3 at the first, second, and third states R_1, R_2, and R_3, respectively, may be expressed by the following Equation 2.

$$E = {K}_{eff} V \qquad [ Equation 2 ]$$

In Equation 2, Keff represents an effective magnetic anisotropy energy density of the free magnetic layer FL, and V represents a volume of the free magnetic layer FL.

According to embodiments of the present disclosure, the removal of the stray magnetic field originating from the pinned magnetic layer PL may result in the energy value E_2 at the second state R_2 being substantially equal to the energy value E_3 at the third state R_3. Consequently, a difference between the energy value E_1 at the first state R_1 and the energy value E_2 at the second state R_2 may be substantially equal to a difference between the energy value E_1 at the first state R_1 and the energy value E_3 at the third state R_3. As a result, the magnetization direction of the free magnetic layer FL may be unintentionally disposed parallel or antiparallel to that of the pinned magnetic layer PL, thereby enabling the security device to generate random numbers.

According to some embodiments, for each of the first PUF cells PUF_1 and the second PUF cells PUF_2, an entropy of about 1 may be obtained using the following Equation 1.

$$S = - [ P {log}_{2} P + ( 1 - P ) {log}_{2} ( 1 - P ) ] \qquad [ Equation 1 ]$$

In Equation 1, S represents entropy, and P represents a probability that a magnetization direction of the free magnetic layer FL of each of the first PUF cells PUF_1 and the second PUF cells PUF_2 will be parallel or antiparallel to the magnetization direction of the pinned magnetic layer PL of each of the first PUF cells PUF_1 and the second PUF cells PUF_2.

According to embodiments of the present disclosure, the removal of a stray magnetic field originating from the pinned magnetic layer PL may allow the free magnetic layer FL to have a magnetization that can be randomly oriented. Consequently, P may be approximately ½. Therefore, for each of the first PUF cells PUF_1 and the second PUF cells PUF_2, according to the present disclosure, the entropy S calculated by Equation 1 may have a value of about 1. In some examples, the entropy S measures randomness of the magnetization direction of the free magnetic layer in each of the plurality of first PUF cells and the plurality of second PUF cells. In some examples, the entropy S is calculated based on a probability of the magnetization direction of the free magnetic layer in each of the plurality of first PUF cells and the plurality of second PUF cells being parallel or pointing in an opposite direction to the magnetization direction of the pinned magnetic layer in each of the plurality of first PUF cells and the plurality of second PUF cell.

Embodiments of the present disclosure may provide a security device capable of generating random numbers and re-establishing unpredictable security keys.

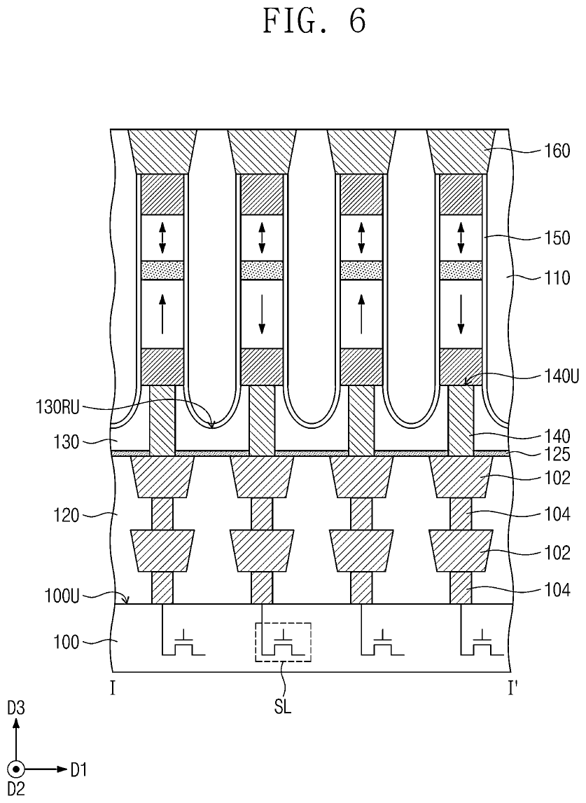

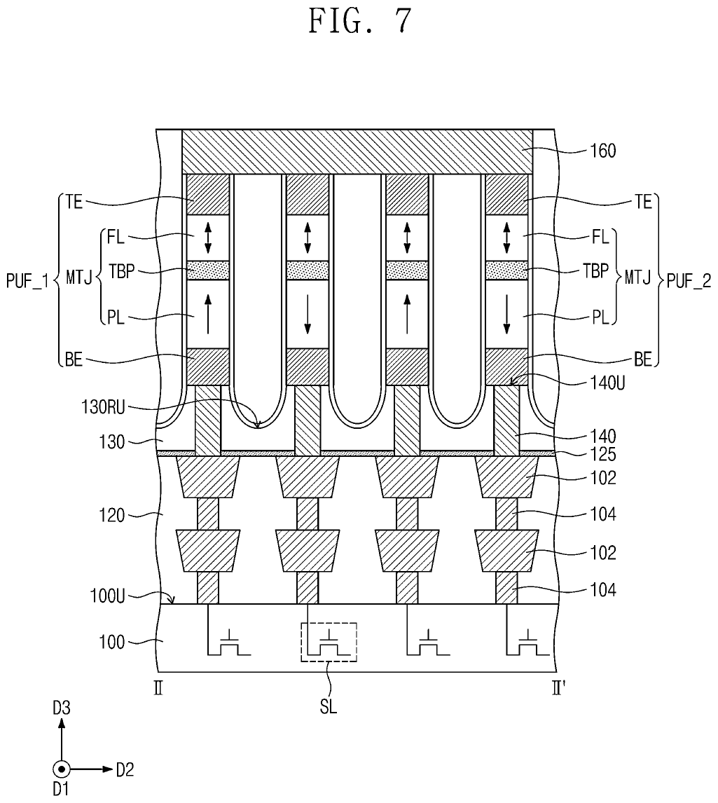

FIG. 6 illustrates a cross-sectional view taken along line I-I′ of FIG. 1, depicting a security device according to some embodiments of the present disclosure. FIG. 7 illustrates a cross-sectional view taken along line II-II′ of FIG. 1, showing a security device according to some embodiments of the present disclosure. For brevity, duplicate explanations of the security device discussed with reference to FIGS. 1 to 5 may be omitted.

With reference to FIGS. 6 and 7, according to some embodiments of the present disclosure, a wiring structure 102 and 104 may be disposed on the substrate 100. The wiring structure 102 and 104 may comprise wiring lines 102 vertically spaced apart from the substrate 100 and wiring contacts 104 connected to the wiring lines 102. The wiring lines 102 may be spaced apart from a top surface 100U of the substrate 100 in a direction perpendicular to the top surface 100U of the substrate 100. The wiring contacts 104 may be disposed between the substrate 100 and the wiring lines 102. Each of the wiring lines 102 may be electrically connected to the substrate 100 through a corresponding one of the wiring contacts 104. In some examples, the wiring lines 102 and the wiring contacts 104 may comprise a metal, such as copper.

According to some embodiments, each of the wiring lines 102 may be electrically connected through a corresponding one of the wiring contacts 104 to one terminal (e.g., a source terminal, a drain terminal, or a gate terminal) of a corresponding one of the selection elements SL.

In some embodiments, a wiring dielectric layer 120 may be disposed on the substrate 100 to cover the wiring structure 102 and 104. The wiring dielectric layer 120 may expose top surfaces of uppermost ones of the wiring lines 102. For example, the wiring dielectric layer 120 may have a top surface substantially coplanar with the top surfaces of the uppermost wiring lines 102. The wiring dielectric layer 120 may comprise one or more materials, such as silicon oxide, silicon nitride, and silicon oxynitride.

According to some embodiments, a first lower dielectric layer 125 may be disposed on the wiring dielectric layer 120 and may cover the exposed top surfaces of the uppermost wiring lines 102. The first lower dielectric layer 125 may comprise one or more materials, such as silicon oxide, silicon nitride, and silicon oxynitride.

In some embodiments, a second lower dielectric layer 130 may be disposed on the first lower dielectric layer 125 and the wiring dielectric layer 120. The second lower dielectric layer 130 may comprise one or more materials, such as silicon oxide, silicon nitride, and silicon oxynitride.

According to some embodiments, the first PUF cells PUF_1 and the second PUF cells PUF_2 may be disposed on the second lower dielectric layer 130. The second lower dielectric layer 130 may have a top surface 130RU that is recessed toward the substrate 100 between the first PUF cells PUF_1 and the second PUF cells PUF_2. The first PUF cells PUF_1 and the second PUF cells PUF_2 may be spaced apart from each other in the first direction D1 and the second direction D2. In some examples, a ratio of the number of the first PUF cells PUF_1 to the number of the second PUF cells PUF_2 may be about 1:1, and the first PUF cells PUF_1 and the second PUF cells PUF_2 may be alternately disposed along the first direction D1 and the second direction D2.

In some embodiments, the second lower dielectric layer 130 may be provided with bottom electrode contacts 140 that are spaced apart from each other in the first direction D1 and the second direction D2. The bottom electrode contacts 140 may be electrically connected to the corresponding first PUF cells PUF_1 and the corresponding second PUF cells PUF_2. In some examples, each of the bottom electrode contacts 140 may penetrate the first lower dielectric layer 125 and the second lower dielectric layer 130, and may be connected to a corresponding one of the uppermost wiring lines 102. Each of the first PUF cells PUF_1 and the second PUF cells PUF_2 may be electrically connected through a corresponding one of the bottom electrode contacts 140 and the uppermost wiring line 102 to one terminal of a corresponding selection element SL.

According to some embodiments, the bottom electrode contacts 140 may have top surfaces 140U located at a height greater than that of the recessed top surface 130RU of the second lower dielectric layer 130. The bottom electrode contacts 140 may comprise at least one material selected from the group consisting of doped semiconductor materials (e.g., doped silicon), metals (e.g., one or more of tungsten, titanium, and tantalum), metal-semiconductor compounds (e.g., metal silicide), and conductive metal nitrides (e.g., one or more of titanium nitride, tantalum nitride, and tungsten nitride).

In some embodiments, a capping dielectric layer 150 may be disposed on the second lower dielectric layer 130. The capping dielectric layer 150 may conformally cover a lateral surface of each of the first PUF cells PUF_1 and the second PUF cells PUF_2 and the recessed top surface 130RU of the second lower dielectric layer 130. When viewed in a plan view, the capping dielectric layer 150 may surround the lateral surface of the first and second PUF cells PUF_1 and PUF_2. The capping dielectric layer 150 may comprise a nitride, such as silicon nitride.

According to some embodiments, a cell dielectric layer 110 may be disposed on the second lower dielectric layer 130 and may cover the first PUF cells PUF_1 and the second PUF cells PUF_2. The cell dielectric layer 110 may fill a space between the first PUF cells PUF_1 and the second PUF cells PUF_2. The capping dielectric layer 150 may be interposed between the cell dielectric layer 110 and the lateral surface of each of the first PUF cells PUF_1 and the second PUF cells PUF_2, and may extend between the cell dielectric layer 110 and the recessed top surface 130RU of the second lower dielectric layer 130. The cell dielectric layer 110 may comprise one or more materials, such as silicon oxide, silicon nitride, and silicon oxynitride. For example, the cell dielectric layer 110 may comprise tetraethylorthosilicate (TEOS) oxide.

In some embodiments, cell conductive lines 160 may be disposed on the first PUF cells PUF_1 and the second PUF cells PUF_2. The cell conductive lines 160 may be spaced apart from each other in the first direction D1 and may each have a linear shape that extends in the second direction D2. Each of the cell conductive lines 160 may be electrically connected to corresponding ones of the first PUF cells PUF_1 and corresponding ones of the second PUF cells PUF_2, which are spaced apart from each other in the first direction D1.

According to embodiments of the present disclosure, by removing the stray magnetic field originating from the pinned magnetic layer PL, the free magnetic layer FL may have a magnetization direction that can be randomly oriented. Consequently, a security device capable of generating random numbers and re-establishing unpredictable security keys may be provided.

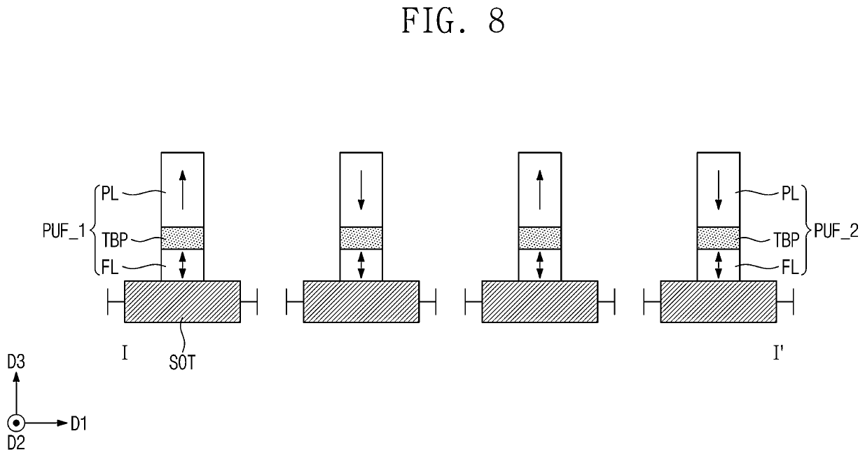

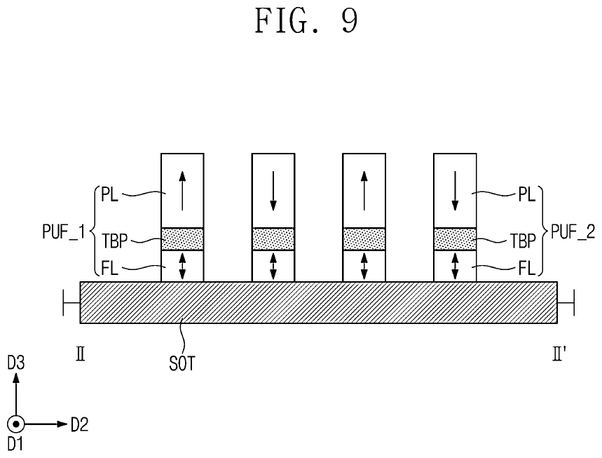

FIG. 8 illustrates a cross-sectional view taken along line I-I′ of FIG. 2, depicting a security device according to some embodiments of the present disclosure. FIG. 9 illustrates a cross-sectional view taken along line II-II′ of FIG. 1, showing a security device according to some embodiments of the present disclosure. For brevity, duplicate explanations of the security device discussed with reference to FIGS. 1 to 5 may be omitted.

With reference to FIGS. 8 and 9, according to some embodiments, the first PUF cells PUF_1 and the second PUF cells PUF_2 may be spaced apart from each other in the first direction D1 and the second direction D2. In some examples, a ratio of the number of the first PUF cells PUF_1 to the number of the second PUF cells PUF_2 may be about 1:1, and the first PUF cells PUF_1 and the second PUF cells PUF_2 may be alternately disposed along the first direction D1 and the second direction D2. According to some embodiments of the present disclosure, each of the first PUF cells PUF_1 and the second PUF cells PUF_2 may comprise a free magnetic layer FL, a pinned magnetic layer PL, and a tunnel barrier layer TBP disposed between the free magnetic layer FL and the pinned magnetic layer PL. The pinned magnetic layer PL of each of the first PUF cells PUF_1 may have a magnetization direction antiparallel to the magnetization direction of the pinned magnetic layer PL of each of the second PUF cells PUF_2.

According to some embodiments, a spin-orbit torque pattern SOT may be disposed below the first PUF cells PUF_1 and the second PUF cells PUF_2. The spin-orbit torque pattern SOT may be configured to provide a spin-orbit torque to the free magnetic layer FL of each of the first PUF cells PUF_1 and the second PUF cells PUF_2. In some examples, a portion of the spin-orbit torque pattern SOT may be in contact with the free magnetic layer FL. The spin-orbit torque pattern SOT may be disposed adjacent to the free magnetic layer FL. When an in-plane current flows through the spin-orbit torque pattern SOT, the spin-orbit torque pattern SOT may provide the free magnetic layer FL with a spin-orbit torque caused by a spin Hall effect or a Rashba effect.

In some embodiments, conductive lines for applying an in-plane current may be connected to opposite ends of the spin-orbit torque pattern SOT. The spin-orbit torque pattern SOT may comprise a heavy metal or a material doped with a heavy metal. In some examples, the spin-orbit torque pattern SOT may comprise a non-magnetic material. The spin-orbit torque pattern SOT may comprise at least one material selected from the group consisting of tantalum (Ta), platinum (Pt), bismuth (Bi), titanium (Ti), and tungsten (W).

According to embodiments of the present disclosure, by removing the stray magnetic field originating from the pinned magnetic layer PL, the free magnetic layer FL may have a magnetization direction that can be randomly oriented. Consequently, a security device capable of generating random numbers and re-establishing unpredictable security keys may be provided.

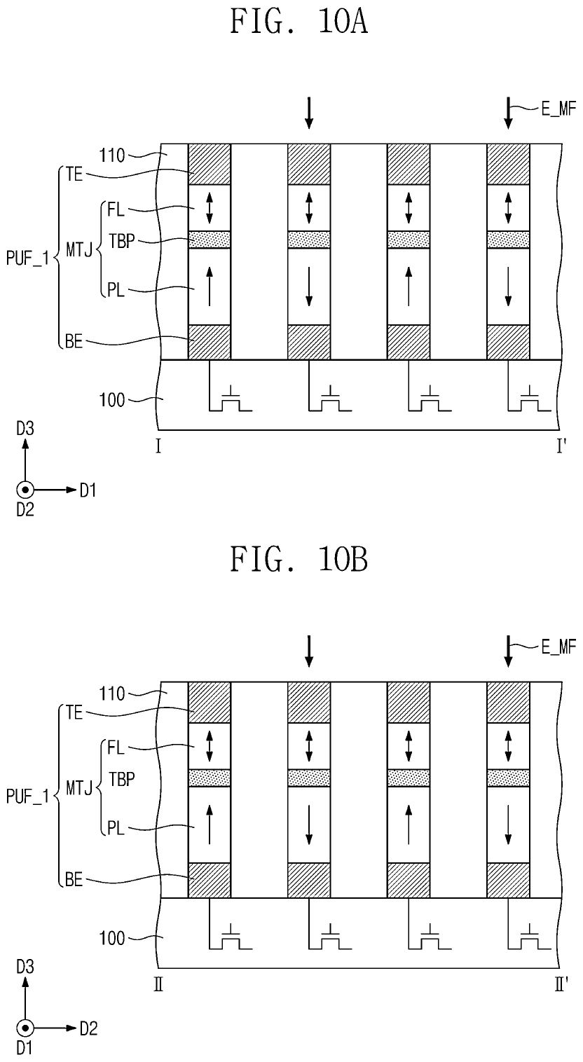

FIG. 10A illustrates a cross-sectional view taken along line I-I′ of FIG. 1, depicting a method of fabricating a security device according to some embodiments of the present disclosure. FIG. 10B illustrates a cross-sectional view taken along line II-II′ of FIG. 1, showing a method of fabricating a security device according to some embodiments of the present disclosure. For brevity, duplicate explanations of the security device discussed with reference to FIGS. 1 to 5 may be omitted.

With reference to FIGS. 10A and 10B, according to some embodiments of the present disclosure, the substrate 100 may be provided with first PUF cells PUF_1 that are spaced apart from each other in the first direction D1 and the second direction D2. The formation of the first PUF cells PUF_1 may include, for example, sequentially forming a bottom electrode layer and a magnetic tunnel junction layer on the substrate 100, forming a conductive mask pattern on the magnetic tunnel junction layer, and using the conductive mask pattern as an etching mask to sequentially etch the magnetic tunnel junction layer and the bottom electrode layer. The magnetic tunnel junction layer may comprise a first magnetic layer, a tunnel barrier layer, and a second magnetic layer that are sequentially stacked on the bottom electrode layer. In some examples, the magnetic tunnel junction layer and the bottom electrode layer may be formed by a sputtering process, a chemical vapor deposition process, or an atomic layer deposition process.

According to some embodiments, the magnetic tunnel junction layer and the bottom electrode layer may be etched to form the magnetic tunnel junction pattern MTJ and the bottom electrode BE, respectively. The etching of the magnetic tunnel junction layer may comprise using the conductive mask pattern as an etching mask to sequentially etch the second magnetic layer, the tunnel barrier layer, and the first magnetic layer. The second magnetic layer, the tunnel barrier layer, and the first magnetic layer may be etched to form the free magnetic layer FL, the tunnel barrier layer TBP, and the pinned magnetic layer PL, respectively. The conductive mask pattern may remain on the magnetic tunnel junction pattern MTJ after the magnetic tunnel junction layer and the bottom electrode layer are etched, and the remaining portion of the conductive mask pattern may be defined as the top electrode TE.

In some embodiments, an external magnetic field E_MF may be applied to one or more of the first PUF cells PUF_1, thereby reversing the magnetic directions of the pinned magnetic layers PL. The application of the external magnetic field E_MF may form second PUF cells PUF_2.

With reference back to FIG. 1, according to some embodiments, the second PUF cells PUF_2 may be formed to align with the first PUF cells PUF_1 in the first direction D1 and the second direction D2. The external magnetic field E_MF may be applied to cause the second PUF cells PUF_2 and the first PUF cells PUF_1 to alternately align with each other in the first direction D1 and the second direction D2.

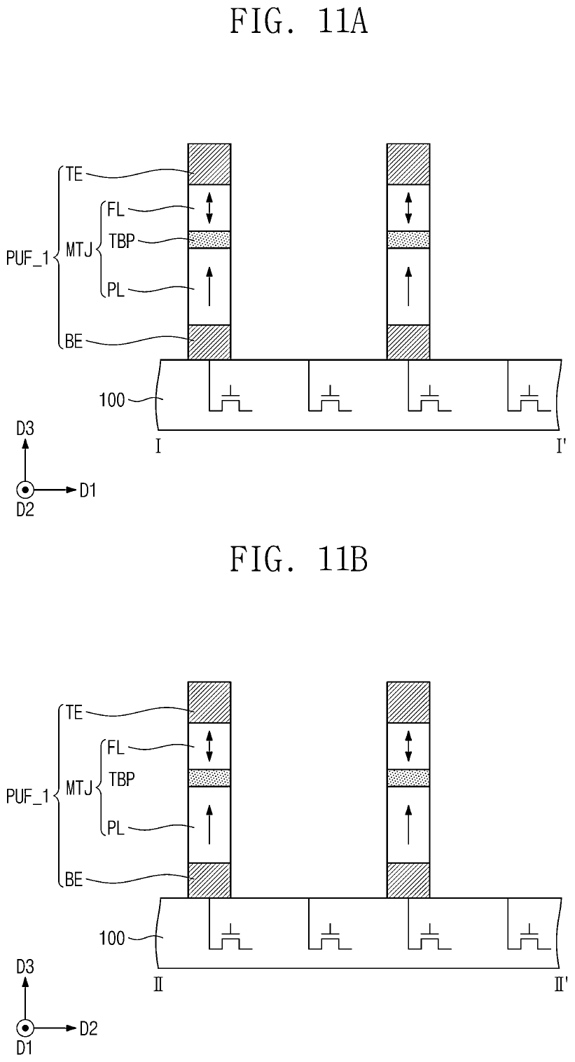

FIG. 11A illustrates a cross-sectional view taken along line I-I′ of FIG. 1, depicting a method of fabricating a security device according to some embodiments of the present disclosure. FIG. 11B illustrates a cross-sectional view taken along line II-II′ of FIG. 1, showing a method of fabricating a security device according to some embodiments of the present disclosure. For brevity, duplicate explanations of the security device discussed with reference to FIGS. 1 to 5 may be omitted.

With reference to FIGS. 11A and 11B, according to some embodiments of the present disclosure, first PUF cells PUF_1 may be formed, which are spaced apart from each other in the first direction D1 and the second direction D2. As discussed with reference to FIGS. 10A and 10B, the formation of the first PUF cells PUF_1 may comprise, for example, sequentially forming a bottom electrode layer and a magnetic tunnel junction layer on the substrate 100, forming a conductive mask pattern on the magnetic tunnel junction pattern, and using the conductive mask pattern as an etching mask to sequentially etch the magnetic tunnel junction layer and the bottom electrode layer.

With reference back to FIGS. 1 to 3, according to some embodiments, second PUF cells PUF_2 may be formed between the first PUF cells PUF_1. The second PUF cells PUF_2 may be formed to have their pinned magnetic layers PL with magnetization directions antiparallel to the magnetization directions of the pinned magnetic layers PL of the first PUF cells PUF_1. In some examples, the formation process for forming the second PUF cells PUF_2 may be substantially the same as the formation process for forming the first PUF cells PUF_1, as discussed with reference to FIGS. 10A and 10B.

According to some embodiments of the present disclosure, first PUF cells and second PUF cells may be alternately disposed in a first direction and a second direction, such that the pinned magnetic layers of the first PUF cells have magnetization directions antiparallel to the magnetization directions of the pinned magnetic layers of the second PUF cells. By alternately disposing the first and second PUF cells with their pinned magnetic layers having antiparallel magnetization directions, stray magnetic fields may be removed. Consequently, a free magnetic layer may have a randomly oriented magnetization direction, enabling the security device to achieve random number generation.

In some embodiments, the security device may produce and utilize unpredictable security keys through the random number generation when the security device is re-established.

The aforementioned description provides some embodiments for explaining the present disclosure. Therefore, the present disclosure are not limited to the embodiments described above, and it will be understood by one of ordinary skill in the art that variations in form and detail may be made therein without departing from the scope of the present disclosure.

What is claimed is:

1. A security device, comprising:
a substrate extending in a first direction and a second direction, wherein the first direction intersects the second direction;
a plurality of first physical unclonable function (PUF) cells disposed on the substrate, wherein the plurality of first PUF cells are spaced apart from each other in the first direction and the second direction; and
a plurality of second physical unclonable function (PUF) cells disposed on the substrate, wherein the second PUF cells are spaced apart from each other in the first direction and the second direction,
wherein each of the plurality of first PUF cells and the plurality of second PUF cells includes a pinned magnetic layer, a free magnetic layer, and a tunnel barrier layer disposed between the pinned magnetic layer and the free magnetic layer, and
wherein a magnetization direction of the pinned magnetic layer of each plurality of first PUF cells is antiparallel to a magnetization direction of the pinned magnetic layer of each of the plurality of second PUF cells.

2. The security device of claim 1, wherein the plurality of first PUF cells and the plurality of second PUF cells are alternately disposed along the first direction and the second direction.

3. The security device of claim 2, wherein the first PUF cells and the second PUF cells are spaced apart at substantially the same interval from each other in the first direction and the second direction.

4. The security device of claim 1, wherein a ratio of the number of the plurality of first PUF cells to the number of the plurality of second PUF cells is about 1:1.

5. The security device of claim 1, wherein a ratio of a vertical thickness of the pinned magnetic layer to a vertical thickness of the free magnetic layer is about 3:1 to about 5:1.

6. The security device of claim 1, wherein the free magnetic layer and the pinned magnetic layer include iron (Fe), cobalt (Co), or nickel (Ni).

7. The security device of claim 1, wherein the tunnel barrier layer includes magnesium oxide, aluminum oxide, hafnium oxide, or titanium oxide.

8. The security device of claim 1, wherein a vertical thickness of the tunnel barrier layer is in about 1 nm to about 2 nm.

9. The security device of claim 1, wherein for each of the first PUF cells and the second PUF cells, an entropy measuring randomness of the magnetization direction of the free magnetic layer in each of the plurality of first PUF cells and the plurality of second PUF cells equals about one.

10. The security device of claim 1, wherein
each of the plurality of first PUF cells and the plurality of second PUF cells has a first energy value at a first state, a second energy value at a second state, and a third energy value at a third state,
a difference between the first energy value and the second energy value is same as a difference between the first energy value and the third energy value,
at the first state, a magnetization direction of the free magnetic layer makes an angle of about 90° with respect to the magnetization direction of the pinned magnetic layer,
at the second state, the magnetization direction of the free magnetic layer makes an angle of about 0° with respect to the magnetization direction of the pinned magnetic layer, and
at the third state, the magnetization direction of the free magnetic layer makes an angle of about 180° with respect to the magnetization direction of the pinned magnetic layer.

11. The security device of claim 1, further comprising:
a wiring structure disposed between the substrate and the first PUF cells and between the substrate and the second PUF cells; and
a plurality of bottom electrode contacts disposed between the wiring structure and the first PUF cells and disposed between the wiring structure and the second PUF cells,
wherein the bottom electrode contacts are correspondingly connected to the plurality of first PUF cells and the plurality of second PUF cells, and
wherein each of the bottom electrode contacts is connected to a corresponding uppermost conductive line of the wiring structure.

12. The security device of claim 11, further comprising:
a capping dielectric layer that covers a lateral surface of each of the first PUF cells and the second PUF cells.

13. A security device, comprising:
a plurality of first physical unclonable function (PUF) cells and a plurality of second physical unclonable function (PUF) cells, wherein the plurality of first PUF cells and the plurality of second PUF cells are alternately arranged in a first direction and spaced apart from each other in the first direction; and
a spin-orbit torque pattern extending in the first direction, wherein the spin-orbit torque pattern is in contact with the plurality of first PUF cells and the plurality of second PUF cells,
wherein each of the plurality of first PUF cells and the plurality of second PUF cells includes a pinned magnetic layer, a free magnetic layer, and a tunnel barrier layer disposed between the pinned magnetic layer and the free magnetic layer,
wherein a magnetization direction of the pinned magnetic layer of each of the plurality of first PUF cell is antiparallel to a magnetization direction of the pinned magnetic layer of each second PUF cell, and
wherein the spin-orbit torque pattern is in contact with the free magnetic layer of each of the plurality of first PUF cells and the plurality of second PUF cells.

14. The security device of claim 13, wherein the first PUF cells and the second PUF cells are spaced apart at substantially the same interval from each other in the first direction.

15. The security device of claim 13, wherein a ratio of the number of the first PUF cells to the number of the second PUF cells is about 1:1.

16. The security device of claim 13, wherein
each of the plurality of first PUF cells and the plurality of second PUF cells has a first energy value at a first state, a second energy value at a second state, and a third energy value at a third state,
a difference between the first energy value and the second energy value is the same as a difference between the first energy value and the third energy value,
at the first state, a magnetization direction of the free magnetic layer makes an angle of about 90° with respect to the magnetization direction of the pinned magnetic layer,
at the second state, the magnetization direction of the free magnetic layer makes an angle of about 0° with respect to the magnetization direction of the pinned magnetic layer, and
at the third state, the magnetization direction of the free magnetic layer makes an angle of about 180° with respect to the magnetization direction of the pinned magnetic layer.

17. The security device of claim 13, wherein a ratio of a vertical thickness of the pinned magnetic layer to a vertical thickness of the free magnetic layer is about 3:1 to about 5:1.

18. The security device of claim 13, wherein a ratio of a vertical thickness of the pinned magnetic layer to a vertical thickness of the free magnetic layer is about 3:1 to about 5:1.

19. The security device of claim 13, further comprising:
a plurality of additional first PUF cells and a plurality of additional second PUF cells, wherein the plurality of additional first PUF cells and the plurality of additional PUF cells are alternately arranged in the first direction,
wherein the plurality of additional first PUF cells neighbor in a second direction to the plurality of second PUF cells, the second direction intersecting the first direction,
wherein the plurality of additional second PUF cells neighbor in the second direction to the plurality of first PUF cells,
wherein each of the plurality of additional first PUF cells and the plurality of additional second PUF cells includes a pinned magnetic layer, a free magnetic layer, and a tunnel barrier layer disposed between the pinned magnetic layer and the free magnetic layer, and
wherein the magnetization direction of the pinned magnetic layer of each of the plurality of first PUF cells and a magnetization direction of each of the plurality of additional first PUF cells are antiparallel to the magnetization direction of the pinned magnetic layer of each of the plurality of second PUF cells and a magnetization direction of each of the plurality of additional second PUF cells.

20. The security device of claim 13, wherein, for each of the first PUF cells and the second PUF cells, an entropy is about one, wherein the entropy is calculated based on a probability of the magnetization direction of the free magnetic layer in each of the plurality of first PUF cells and the plurality of second PUF cells being parallel or pointing in an opposite direction to the magnetization direction of the pinned magnetic layer in each of the plurality of first PUF cells and the plurality of second PUF cell.
